(19) United States
(12) Patent Application Publication
(10) Pub. No.: US 2012/0166979 A1
(43) Pub. Date: Jun. 28, 2012

(54) Method and Apparatus for Enabling User Interface Customization

(75) Inventor: Stephen Paul Lewontin, Cambridge, MA (US)

(73) Assignee: NOKIA CORPORATION, Espoo (FI)

(21) Appl. No.: 13/172,527

(22) Filed: Jun. 29, 2011

Related U.S. Application Data
(60) Provisional application No. 61/360,779, filed on Jul. 1, 2010.

(51) Int. Cl. G06F 3/01

(52) U.S. Cl. 715/762

(57) ABSTRACT

A method and apparatus are provided that may enable user interface customization. In this regard, for example, some embodiments may enable customization of a web browser user interface for specific web content.

### RELATED APPLICATION

This application claims priority to U.S. application Ser. No. blah filed blah, which is incorporated herein by reference in its entirety.

### TECHNOLOGICAL FIELD

Embodiments of the present invention relate generally to user interface technology and, more particularly, relate to an apparatus and method for enabling user interface customization.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of electronic devices and by improving network performance. One area in which there is a demand to increase ease of information transfer relates to the delivery of services to a user of an electronic device. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. Alternatively, the network device may respond to commands or requests made by the user (e.g., content searching, mapping or routing services, etc.). The services may be provided from a network server or other network device, or even from a mobile terminal such as, for example, a mobile telephone, a mobile navigation system, a mobile computer, a mobile television, a mobile gaming system, etc.

User interfaces (UIs) associated with various applications and/or services (e.g., web services) may be accessible via mobile terminals (or other perhaps fixed communication devices) and may be provided, in some cases, via a layout or rendering engine that utilizes marked up content for the generation of displayable formatted elements. User interfaces for native applications (e.g., applications written and compiled to run as a native executable) are typically generated using proprietary markup languages that may require special-purpose proprietary generation tools and libraries. Meanwhile, non-proprietary markup languages (e.g., like HTML (hypertext markup language) may be fairly standard and widely available, but limited to usage in generating user interfaces for web applications (e.g., applications written in HTML, JavaScript or cascading style sheets (CSS) in order to run in a web rendering environment such as a browser or widget engine) and web widgets.

Web application user interfaces are often inefficient at performing certain tasks (e.g., media playing) that require highly-tuned, platform specific native code. Web environments therefore often support platform native plugins that run as controls within a browsing user interface window. Web applications are also typically forced to mix content presentation with user interface controls. The limitations associated with non-proprietary markup languages used for web application user interfaces and the proprietary nature of markup languages used to generate native application user interfaces can cause inefficiency and unnecessary complexity in relation to generating user interfaces for a variety of different applications and services.

Accordingly, it may be desirable to provide an improved mechanism for user interface generation and customization.

### BRIEF SUMMARY

A method and apparatus are therefore provided that may enable user interface customization. In this regard, for example, some embodiments may enable customization of a web browser user interface for specific web content.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one example of a communication system according to an example embodiment of the present invention;

FIG. 2 illustrates a schematic block diagram of an apparatus for enabling user interface customization according to an example embodiment of the present invention;

FIG. 3 illustrates a flowchart of a method of enabling user interface customization in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Mobile terminals and other electronic computing and/or communication devices are becoming very common and very personal to their respective users. As such, the user interface options offered by these devices should be appealing to the users. Moreover, in a world where users can relatively cheaply and easily shift from one application (or event device) to another simply because they enjoy one user interface offered on one platform more than another, it is a powerful incentive to provide robust user interfaces to users. However, as indicated above, generation of user interfaces can be complicated by the fact that the generation of user interfaces for native applications using declarative markup languages (e.g., a markup language based on a logical document model that describes the logical structure of a document independent of its physical representation) typically requires the use of proprietary markup languages. However, non-proprietary markup languages like HTML typically have not been used as a declarative markup for native application user interface generation. Instead, HTML has been used in relatively limited ways as a customization mechanism.

It is common for applications to modify their user interface depending on the current view and other state of the application. For example, mail/calendar programs typically show one set of menu items when viewing mail and a different set of menu items when viewing calendar items. Web browsers typically treat each open window as a content view, and all content views typically have the same user interface. Specifically, the browser user interface does not change depending on the content being shown. Some embodiments of the present invention may, however, provide a mechanism by which to enable the browser user interface to be altered based on the content being shown.

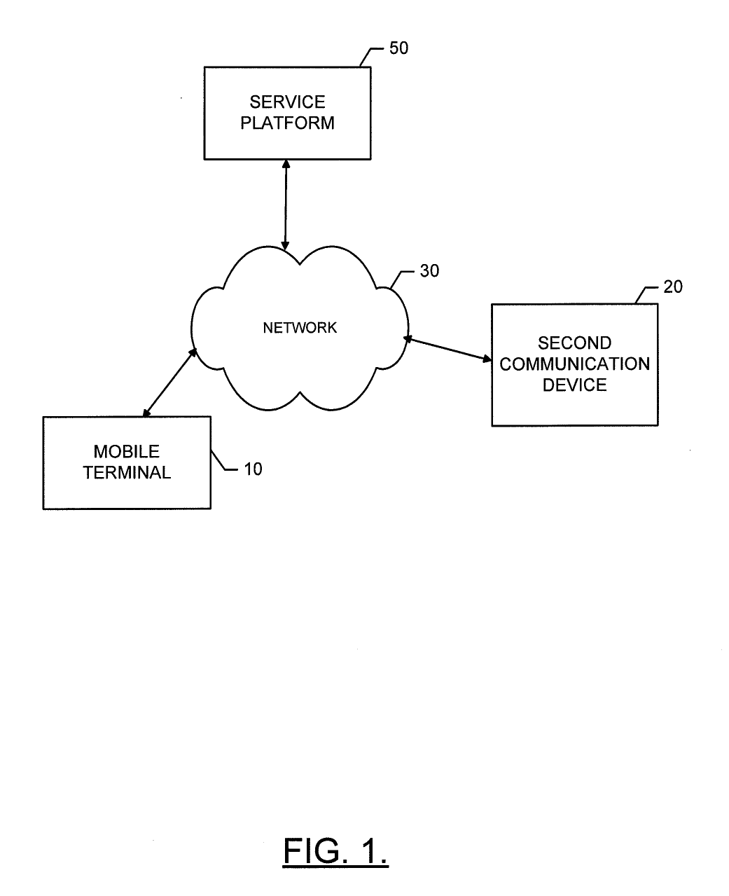

FIG. 1 illustrates a generic system diagram in which a device such as a mobile terminal 10, which may benefit from embodiments of the present invention, is shown in an example communication environment. As shown in FIG. 1, an embodiment of a system in accordance with an example embodiment of the present invention may include a first communication device (e.g., mobile terminal 10) and a second communication device 20 capable of communication with each other. In an example embodiment, the mobile terminal 10 and the second communication device 20 may be in communication with each other via a network 30. In some cases, embodiments of the present invention may further include one or more network devices with which the mobile terminal 10 and/or the second communication device 20 may communicate to provide, request and/or receive information.

It should be noted that although FIG. 1 shows a communication environment that may support client/server application execution, in some embodiments, the mobile terminal 10 and/or the second communication device 20 may employ embodiments of the present invention without any network communication. As such, for example, embodiments of the present invention may be practiced with respect to applications executed locally at the mobile terminal 10 and/or the second communication device 20. However, in some alternative cases, embodiments may be practiced with respect to content served to the mobile terminal 10 and/or the second communication device 20 via a wired or wireless link to another device acting as a server. For example, as shown in FIG. 1, an embodiment of a system in accordance with an example embodiment of the present invention may further include a service platform 50 capable of communication with the mobile terminal 10 and/or the second communication device 20 via a network 30. In some cases, embodiments of the present invention may further include one or more network devices or other mobile or fixed communication devices with which the mobile terminal 10, the second communication device 20 and/or the service platform 50 may communicate to provide, request and/or receive information. The network devices may include, for example, one or more servers, base stations, access points, gateways, communication controllers or other computers configured to perform various functions. In some cases, embodiments of the present invention may also or alternatively be practiced on one or more of the network devices and/or the communication devices that communicate with each other and/or the network devices.

In an example embodiment, the service platform 50 may be a device or node such as a server or other processing circuitry. The service platform 50 may have any number of functions or associations with various services. As such, for example, the service platform 50 may be a platform such as a dedicated server, backend server, or server bank associated with a particular information source, function or service. As such, the service platform 50 may represent one or more of a plurality of different services or information sources. The functionality of the service platform 50 may be provided by hardware and/or software components configured to operate in accordance with known techniques for the provision of information to users of communication devices, except as modified as described herein.

The network 30, if employed, may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. One or more communication terminals such as the mobile terminal 10 and the second communication device 20 may be in communication with the network 30 or even with each other via the network 30 or via device to device (D2D) communication and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices (e.g., personal computers, server computers or the like) may be coupled to the mobile terminal 10 and/or the second communication device 20 via the network 30. By directly or indirectly connecting the mobile terminal 10 and/or the second communication device 20 and other devices to the network 30 or to each other, the mobile terminal 10 and/or the second communication device 20 may be enabled to communicate with the other devices or each other, for example, according to numerous communication protocols including Hypertext Transfer Protocol (HTTP) and/or the like, to thereby carry out various communication or other functions of the mobile terminal 10 and the second communication device 20, respectively.

Furthermore, although not specifically shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, the first communication device (e.g., the mobile terminal 10) may be a mobile communication device such as, for example, a PDA, wireless telephone, mobile computing device, camera, video recorder, audio/video player, positioning device (e.g., a GPS device), game device, television device, radio device, or various other like devices or combinations thereof. The second communication device 20 may also be a mobile device such as those listed above or other mobile or embedded devices, but could also be a fixed communication device (e.g., a personal computer (PC) or a network access terminal) in some instances.

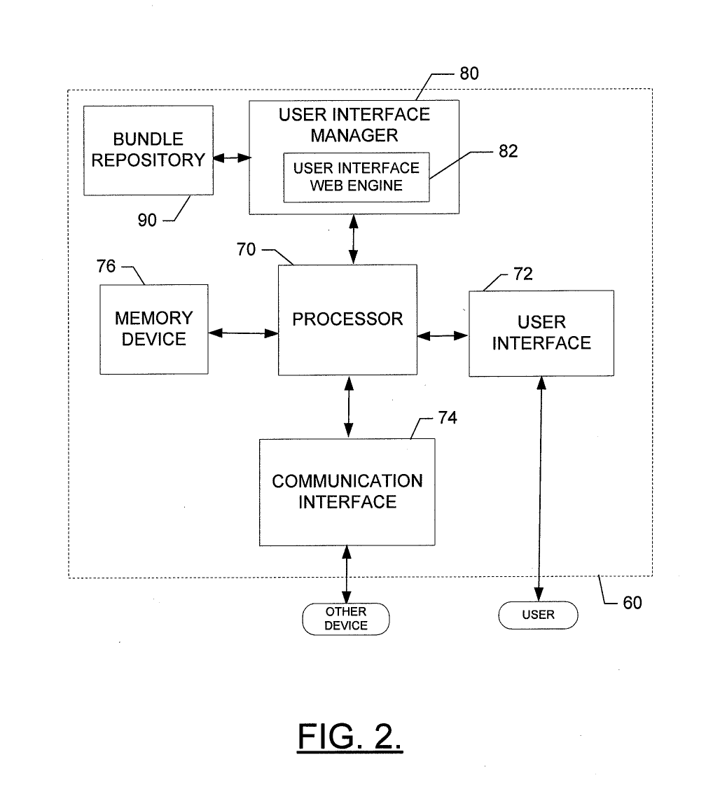

In an example embodiment, the mobile terminal 10 (and/or the second communication device 20 or some other network device such as the service platform 50) may be configured to include or otherwise employ an apparatus according to an example embodiment of the present invention. FIG. 2 illustrates a schematic block diagram of an apparatus for enabling customization of a user interface according to an example embodiment of the present invention. An example embodiment will now be described with reference to FIG. 2, in which certain elements of an apparatus 60 for providing user interface customization are displayed. The apparatus 60 of FIG. 2 may be employed, for example, on a communication device (e.g., the mobile terminal 10 and/or the second communication device 20) or a variety of other devices (e.g., service platform 50). However, it should be noted that the components, devices or elements described below may not be mandatory and thus some may be omitted in certain embodiments. Additionally, some embodiments may include further components, devices or elements beyond those shown and described herein.

Referring now to FIG. 2, the apparatus 60 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device). The memory device 76 may be configured to store information, data, applications, instructions or the like for enabling the apparatus to carry out various functions in accordance with example embodiments of the present invention. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, processing circuitry, or the like. In an exemplary embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., the mobile terminal 10 or the second communication device 20) adapted for employing embodiments of the present invention by further configuration of the processor 70 by instructions for performing the algorithms and/or operations described herein. By executing the instructions or programming provided thereto or associated with the configuration of the processor 70, the processor 70 may cause corresponding functionality to be performed. The processor 70 may include, among other things, a clock, an arithmetic logic unit (ALU) and logic gates configured to support operation of the processor 70.

Meanwhile, the communication interface 74 may be any means such as a device or circuitry embodied in either hardware, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices (e.g., the service platform 50), the user interface 72 may be limited, or eliminated. However, in an embodiment in which the apparatus is embodied as a communication device (e.g., the mobile terminal 10 or the second communication device 20), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an exemplary embodiment, the processor 70 may be embodied as, include or otherwise control a user interface manager 80. As such, in some embodiments, the processor 70 may be said to cause, direct or control the execution or occurrence of the various functions attributed to the user interface manager 80 as described herein. The user interface manager 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the user interface manager 80 as described herein. Thus, in examples in which software is employed, a device or circuitry (e.g., the processor 70 in one example) executing the software forms the structure associated with such means.

In an example embodiment, the user interface manager 80 may be configured to act as or otherwise operate a user interface web engine 82. The user interface web engine 82 may be software configured to act as a layout or rendering engine for using user interface declaration information to provide formatted content for display (e.g., to a display of the user interface 72). As such, the user interface manager 80 (e.g., via the processor 70) may be responsible for causing the functionality described herein in reference to the user interface web engine 82. In some embodiments, the user interface web engine 82 may operate in connection with a connectivity program, such as a web browser. The connectivity program may then allow the mobile terminal 10 to transmit and receive web content, such as location-based content and/or other web page content, according to a Wireless Application Protocol (WAP), Hypertext Transfer Protocol (HTTP) and/or the like, for example.

The user interface web engine 82 may be configured to generate user interface elements based on user interface declaration information corresponding to a user interface bundle determined based on content received for rendering. As such, the user interface web engine 82 may be configured to receiving content from a content source (e.g., via a network) and determine a user interface bundle corresponding to the received content. After the user interface bundle is determined, the user interface web engine 82 may be configured to generate user interface elements for a user interface based on the user interface declaration information. In other words, while a typical web page renders all of the elements therein within a single user interface window, the user interface web engine 82 may be configured to generate user interface elements for one or more different content views such that each content view may have its own customized user interface based on the content that is to be rendered.

In an example embodiment, the user interface declaration information may be machine-readable descriptive information that specifies the layout, appearance and behavior of an application user interface and its components. The user interface bundle may include the user interface declaration information and a set of resources (e.g., images and/or code modules) to be used for instantiation of an interface. As such, for example, the user interface bundle may include HTML, CSS, JavaScript, and/or the like user interface declarations along with any images and native user interface elements to be used by the user interface web engine 82 to generate a particular user interface. In some embodiments, the user interface bundle may be modified by substituting one or more components without necessarily replacing all of the components. In other words, for example, the user interface bundle may be customized by enabling any one or more of the components of the user interface bundle (e.g., HTML, JavaScript or CSS) to be substituted or modified, while leaving one or more of the remaining components unaltered in order to generate a modified or new user interface.

In an example embodiment, user interface bundles may be stored in a bundle repository 90. The bundle repository 90 may be a portion of the memory device 76 in some embodiments (e.g., when user interface bundle information is stored locally at a mobile terminal employing the apparatus 60). However, in some embodiments, the bundle repository 90 could alternatively be some other remotely located memory device (e.g., when user interface bundle information is stored at the service platform 50 and the mobile terminal 10 access such information as a client device based on content to be displayed).

In an example embodiment, the bundle repository 90 may store user interface bundles that correspond to specific content received at the apparatus 60. As such, based on the content received, customized user interface elements may be generated. In some examples, each user interface configuration that is capable of being generated may be generated based on a corresponding user interface bundle. The bundle repository 90 may therefore store a plurality of user interface bundles. The user interface bundles may be predefined bundles correlated with specific types of content or specific content providers. However, in some cases, the user interface bundles may include one or more general category bundles or default bundles that are employed when no specific user interface bundle is specified by the content received for rendering.

In an example embodiment, user interface bundles may be uniquely identified by a bundle identifier. The bundle identifier may be, for example, a uniform resource locator (URL), a uniform resource name (URN) and/or the like. In an example embodiment, when content is loaded by the mobile terminal 10 (e.g., via the web browser or the user interface manager 80), the bundle identifier corresponding to the content may be determined by the user interface web engine 82. The user interface web engine 82 may then access the corresponding user interface bundle associated with the bundle identifier determined by retrieving the user interface bundle from the bundle repository. In some embodiments, the user interface web engine 82 may maintain or otherwise access a mapping between bundle identifiers and corresponding address information of the content source (e.g., URL, URL components, domain names, and/or the like). In some cases, the bundle identifier corresponding to content downloaded may be determined by the user interface web engine 82 from the content itself. For example, content may identify its corresponding user interface bundle via a tag or metadata (e.g., an HTML <meta> tag such as <meta name=“uibundle” content=“urn:uibundle: 0AC24FB321″>. In some cases, the loaded content may itself include user interface bundle components and may be marked with a content type indicator (e.g., application/x-uibundle). The user interface web engine 82 may indicate that it is configured to or otherwise enabled to handle a corresponding content type. For example, an HTTP accept header may be issued so that a content service may be enabled to provide user interface bundle content. The provided bundle content may be stored in the bundle repository for use in the future with similar content types, or may simply be used one time for the corresponding content in association with which the bundle content was provided. In some cases, user interface bundles may have variants, as described above. Thus, for example, user interface bundles may share a set of common code and each variant may provide one or more specific components. As an example, some variants may differ only in the CSS component (or the HTML or JavaScript component). Accordingly, user interface bundles may be stored in a repository in such a way that common components may not be duplicated, but may instead be shared among bundles. The bundle that determines the user interface at any instant may be constructed by combining common and variant elements. Accordingly, for example, a mapping from content to interface bundles may be a mapping to variant components only (e.g., in a user interface in which only a single component (e.g., CSS) is customizable). As such, downloading a customized bundle may require only downloading of variant components for inclusion with already downloaded common components.

In some embodiments, since user interface bundles may be provided from external sources, and since a user interface bundle may impact the security and integrity of a browser application, the user interface web engine 82 may be further configured to employ authentication and security checks to downloaded bundles. Thus, for example, the user interface web engine 82 may be configured to provide for secure local storage of user interface bundles and/or provide for protection against installation of unauthorized user interface bundles or user interface bundles that fail, for some reason, to pass security related checks.

Some embodiments of the present invention may therefore provide a mechanism by which to utilize the user interface web engine 82 or a web browser application to customize the user interface for each content view being shown. As such, information about the content being shown (e.g., the domain of the URL) may be used to trigger user interface customization. Accordingly, content providers can customize or extend the browser user interface to include specific features appropriate to their services or otherwise create a look and feel consistent with the provider brand.

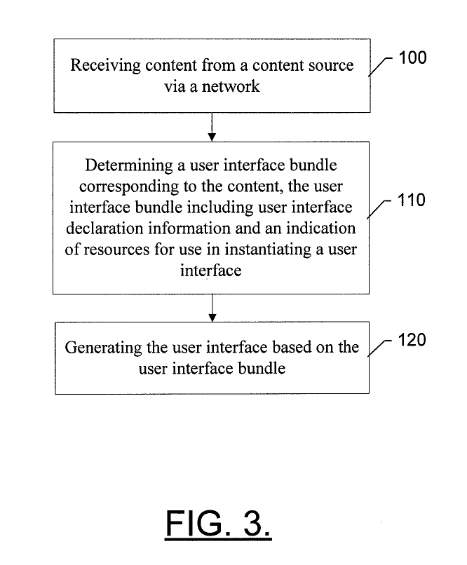

FIG. 3 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method for enabling user interface customization, as shown in FIG. 3, includes receiving content from a content source via a network at operation 100. The method further includes determining a user interface bundle corresponding to the content received at operation 110. The user interface bundle includes user interface declaration information and an indication of resources for use in instantiating a user interface. The method further includes generating the user interface based on the user interface bundle at operation 120.

In some embodiments, certain ones of the operations above may be modified or further amplified as described below. Modifications or amplifications to the operations above may be performed in any order and in any combination. In this regard, for example, determining the user interface bundle may include determining the user interface bundle based on a bundle identifier indicated in the content received. In some embodiments, determining the user interface bundle may include determining the user interface bundle based on a bundle identifier determined via a mapping to an address associated with the content source (e.g., a URL or URL domain of the content source). In an example embodiment, determining the user interface bundle may include determining the user interface bundle based on bundle components specified in the content received. In some embodiments, the bundle components may include common components shared among a plurality of bundles and variant components that are specific to a particular user interface. In some examples, generating the user interface may include utilizing the user interface declaration, which comprises a machine readable description of the layout, appearance and/or behavior of the user interface and its components, to generate the interface. In an example embodiment, determining the user interface bundle may further include applying authentication and/or integrity checks to the user interface bundle.

In an example embodiment, an apparatus for performing the method of FIG. 3 above may comprise a processor (e.g., the processor 70) configured to perform some or each of the operations (100-120) described above. The processor may, for example, be configured to perform the operations (100-120) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-120 may comprise, for example, the processor 70, the user interface manager 80, and/or a device or circuit for executing instructions or executing an algorithm for processing information as described above.

In some cases, the operations (100-120) described above, along with any of the modifications may be implemented in a method that involves facilitating access to at least one interface to allow access to at least one service via at least one network. In such cases, the at least one service may be to perform at least operations 100-120.

An example of an apparatus according to an example embodiment may include at least one processor and at least one memory including computer program code. The at least one memory and the computer program code may be configured to, with the at least one processor, cause the apparatus to perform the operations 100-120 (with or without the modifications and amplifications described above in any combination).

An example of a computer program product according to an example embodiment may include at least one computer-readable storage medium having computer-executable program code portions stored therein. The computer-executable program code portions may include program code instructions for performing operation 100-120 (with or without the modifications and amplifications described above in any combination).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to at least:
receive content from a content source via a network;
determine a user interface bundle corresponding to the content received, the user interface bundle including user interface declaration information and an indication of resources for use in instantiating a user interface; and
cause generation of the user interface based on the user interface bundle.

2. The apparatus of claim 1, wherein the memory and computer program code are configured to, with the processor, cause the apparatus to determine the user interface bundle by determining the user interface bundle based on a bundle identifier indicated in the content received.

3. The apparatus of claim 1, wherein the memory and computer program code are configured to, with the processor, cause the apparatus to determine the user interface bundle by determining the user interface bundle based on a bundle identifier determined via a mapping to an address associated with the content source.

4. The apparatus of claim 1, wherein the memory and computer program code are configured to, with the processor, cause the apparatus to determine the user interface bundle by determining the user interface bundle based on bundle components specified in the content received.

5. The apparatus of claim 4, wherein the bundle components include common components shared among a plurality of bundles and variant components that are specific to a particular user interface.

6. The apparatus of claim 4, wherein the memory and computer program code are configured to, with the processor, cause the apparatus to generate the user interface by utilizing the user interface declaration, which comprises a machine readable description of the layout, appearance or behavior of the user interface and components of the user interface bundle, to generate the user interface.

7. The apparatus of claim 4, wherein the memory and computer program code are configured to, with the processor, cause the apparatus to determine the user interface bundle by applying authentication or integrity checks to the user interface bundle.

8. The apparatus of claim 1, wherein the apparatus is a mobile terminal and further comprises user interface circuitry configured to facilitate user control of at least some functions of the mobile terminal.

9. A method comprising:
receiving content from a content source via a network;
determining a user interface bundle corresponding to the content received, the user interface bundle including user interface declaration information and an indication of resources for use in instantiating a user interface; and
causing generation of the user interface based on the user interface bundle.

10. The method of claim 9, wherein determining the user interface bundle comprises determining the user interface bundle based on a bundle identifier indicated in the content received.

11. The method of claim 9, wherein determining the user interface bundle comprises determining the user interface bundle based on a bundle identifier determined via a mapping to an address associated with the content source.

12. The method of claim 9, wherein determining the user interface bundle comprises determining the user interface bundle based on bundle components specified in the content received.

13. The method of claim 12, wherein the bundle components include common components shared among a plurality of bundles and variant components that are specific to a particular user interface.

14. The method of claim 9, wherein generating the user interface comprises utilizing the user interface declaration, which comprises a machine readable description of the layout, appearance or behavior of the user interface and components of the user interface bundle, to generate the user interface.

15. The method of claim 9, wherein determining the user interface bundle comprises applying authentication or integrity checks to the user interface bundle.

16. A computer program product comprising at least one computer-readable storage medium having computer-executable program code portions stored therein, the computer-executable program code portions comprising program code instructions for:
receiving content from a content source via a network;
determining a user interface bundle corresponding to the content received, the user interface bundle including user interface declaration information and an indication of resources for use in instantiating a user interface; and
causing generation of the user interface based on the user interface bundle.

17. The computer program product of claim 16, wherein program code instructions for determining the user interface bundle include instructions for determining the user interface bundle based on a bundle identifier indicated in the content received.

18. The computer program product of claim 16, wherein program code instructions for determining the user interface bundle include instructions for determining the user interface bundle based on a bundle identifier determined via a mapping to an address associated with the content source.

19. The computer program product of claim 16, wherein program code instructions for determining the user interface bundle include instructions for determining the user interface bundle based on bundle components specified in the content received.

20. The computer program product of claim 16, wherein program code instructions for generating the user interface include instructions for utilizing the user interface declaration, which comprises a machine readable description of the layout, appearance or behavior of the user interface and components of the user interface bundle, to generate the user interface.
